(19) United States
(12) Patent Application Publication
(10) Pub. No.: US 2009/0241794 A1
(43) Pub. Date: Oct. 1, 2009

(54) NOISE GENERATING DEVICE TO SCARE BIRDS OR TRIGGER AVALANCHES

(76) Inventor: Michael Eggers, Nelson (NZ)

Correspondence Address: OSRAM SYLVANIA INC, 100 ENDICOTT STREET, DANVERS, MA, 01923, US

(21) Appl. No.: 12/303,141

(22) PCT Filed: Jun. 5, 2007
(86) PCT No.: PCT/NZ2007/000136

§ 371 Date: Jun. 9, 2009

(30) Foreign Application Priority Data
Jun. 2, 2006 (NZ) 547651

(51) Int. Cl. F42D 3/00; F42B 4/00; A01M 29/04

(52) U.S. Cl. 102/302; 102/335; 116/22 A

(57) ABSTRACT

A noise generating device (1) for scaring away animals such as birds over a large area or initiating avalanches. The device includes an enclosed combustion chamber (2) having a single exit opening (3) and two inlet valves (9), an element for introducing a combustible material such as acetylene gas, an ignition element, an inner barrel (6) extending away from the exit opening (3) and an outer barrel (8) extending away the exit opening (3) and surrounding the inner barrel (6). The outer barrel (8) extends beyond the inner barrel (6) and extends outwards to form an inverted cone. Once combustion has started, rapidly expanding gases are forced through the exit (3) and as the gases move between the inner barrel and the outer barrel an audible noise/shock wave is generated. The device can be used by orchardist, market gardeners, grape growers, and in the fishing and aeronautics industries.

### FIELD OF INVENTION

The invention relates to a device for generating a noise.

### BACKGROUND

The presence of birds in certain undesirable areas can pose both an economic cost and a potential hazard.

For example birds can impose a large economic burden upon orchardists, market gardeners, grape growers and the like. Even in the fishing industry the impact of scavenging birds when large fishing nets are being pulled up can have a significant economic impact.

Birds can also pose a significant hazard, particularly in the aeronautics industry. Bird strikes by aircraft, especially while landing or taking off at airports, pose a significant hazard and have been linked to fatal accidents. Many airports employ measures to discourage birds in the area.

Many methods are employed to discourage birds from particular areas. One method is to place netting around an area to prevent birds getting access. For example, nets are often placed over fruiting vines or trees. However, this can be expensive, and only provides protection over small areas. Furthermore, nets deteriorate over time and often tear, which requires ongoing maintenance.

Another method that has been employed is to use imitation predatory animals. For example U.S. Pat. No. 6,807,765 teaches the use of silhouettes of a bird of prey to scare away birds. While this method may be employed to cover a larger area, it does have the disadvantage that birds often learn that the imitations are not real and the effects may not be long lasting.

Another method often employed is to use noise to scare away birds. While this approach can be very successful, it is difficult to generate a sound with such ferocity and penetration as to scare birds over a large distance. One approach that has been employed in airports is to mount speakers on a vehicle, which constantly travels around scaring away birds. This has the disadvantage that it is quite labour intensive. Other approaches have been to use random firing of blank ammunition, or a small explosive. This can be effective to startle an animal, but is often only effective over short ranges.

Use of large noise generating devices also have other applications. For example the shock wave from a noise generating device can be used to trigger avalanches. This allows controlled avalanche initiation to prevent larger avalanches accumulating in dangerous areas.

Therefore the object of the present invention is to provide a device capable of generating a significant noise in order to scare birds or other animals over a large area or to initiate avalanches or the like, or to at least provide the public with a useful alternative.

### SUMMARY OF THE INVENTION

According to a first aspect the invention provides for a noise generating device comprising
an enclosed combustion chamber having a single exit opening;
a means for introducing a combustible material;
an ignition means;
an inner barrel extending away from the combustion chamber exit opening;
an outer barrel extending away from the combustion chamber exit opening, and surrounding said inner barrel,
   wherein said outer barrel extends beyond said inner barrel.

The outer band can extend from the end of the inner band.

The outer barrel extends outwards from a centre line at an angle of between 0 to 45° forming an inverted cone.

The combustion chamber can comprise one or more one way valves that allow gases to enter said chamber. The one or more valves can comprise an opening in the combustion chamber that has a sealing flap that opens into the combustion chamber. Said valve can project into said combustion chamber. Furthermore, the flap of the inlet valve can be biased in an open position. In another embodiment the combustion chamber may be tapered to the exit opening.

The device according to the first aspect can be a bird scarer or an avalanche inducing device.

In a second aspect the invention provides for a method of generating a noise using a device according to the first aspect of the invention comprising the steps of:
introducing a combustible material into the combustion chamber,
igniting said combustible material,
   wherein the exiting of the expanding combustion gases through the inner and outer barrels produce an audible sound.

The combustible material can be a gas and may include acetylene. Oxygen may also be introduced into the combustion chamber prior to ignition.

The invention also includes a method of scaring birds comprising producing a noise according to the method of the second aspect of the invention.

The invention also includes a method of avalanche control, comprising initiating an avalanche using a noise generated by the method of the second aspect of the invention.

### DETAILED DESCRIPTION OF THE INVENTION

The invention will now be explained by way of example with reference to the following figures:

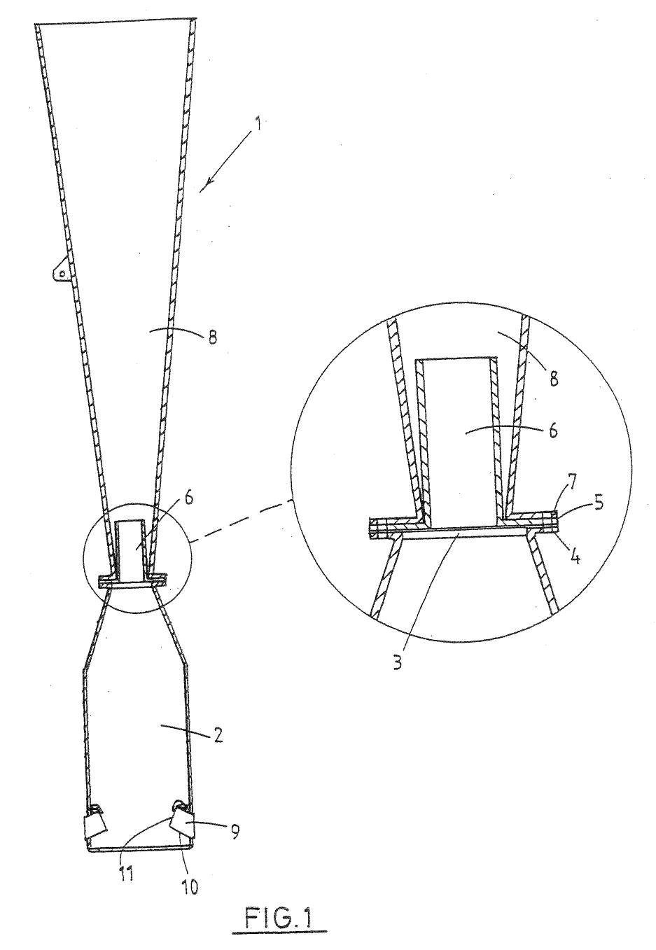

FIG. 1 shows a sectioned view of the device

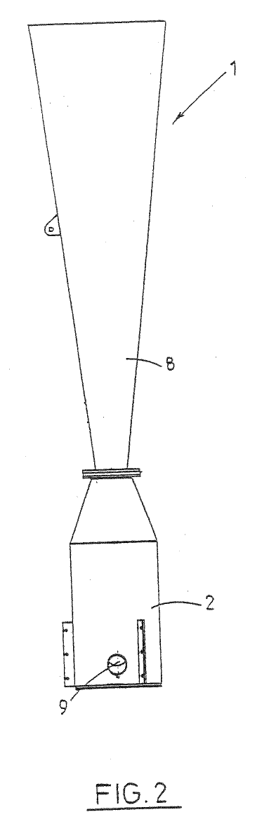

FIG. 2 shows a side view of the device

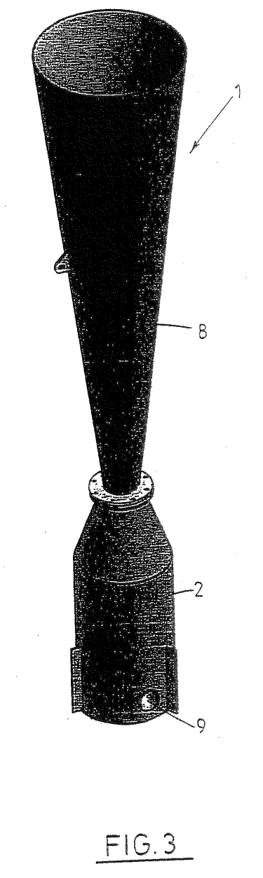

FIG. 3 shows a perspective view of the device

As shown in the figures the invention comprises a noise generating device 1. The device 1 comprises a combustion chamber 2 that tapers to a single exit opening 3. The combustion chamber exit opening 3 has an outer flange 4 which bolts to an outer flange 5 of an inner barrel 6, which consists of a round pipe that extends away from the exit 3. Also bolted to the exit flange 4 is a flange 7 of an outer barrel 8, which consists of an upwardly and outwardly extending funnel, which surrounds the inner barrel 6 and extends beyond the length of the inner barrel 6. The combustion chamber 2 also has means for introducing a combustible material (not shown), and an ignition means (not shown) for igniting the combustible material.

The combustion chamber also includes two inlet valves 9. The inlet valve 9 consists of a circular passage 10 extending into the combustions chamber 2 at an angle towards the exit opening 3. A hinged sealing plate 11 is positioned over then end of the passage 10, and is biased in an open position in which the sealing plate does not seal the passage 10.

The outer barrel 8 does not have to be conical in shape. Any shape could be used provided it extends beyond the inner barrel 6.

In use a combustible material is introduced into the combustion chamber 1. Any suitable form of highly combustible material could be used, but ideally is a gas, such as acetylene or the like. As the combustion chamber 1 is filled air is able to also enter the chamber 1 via the open inlet valve 9. The air aids in the combustion process. It is important to note that the inlet valve 9 is not essential, but acts to aid the filling of the combustion chamber 1. Furthermore, other additives can be used to aid combustion, such as adding oxygen.

The combustible material in the chamber is then ignited. Ignition can be accomplished by any suitable means, such as a spark from and an electric ignition system.

Once combustion has started the rapidly expanding gasses push against the sealing plate 11 of the inlet valve 9, moving them into a closed position in which the sealing plate 11 seals the passage 10. The expanding gases are then forced out through the exit 3, through the inner barrel 6 into the outer barrel 8 and then into the atmosphere. As the gases move between the inner barrel 6 and outer barrel 8 an audible noise is generated.

Following ignition there is a noise generated by the device that is separate and additional to that generated by the actual explosion of the combustible material that has been introduced into the blast chambers. The noise is a result of a specific pressure wave that has been generated as the energy escapes from the blast chamber through the inner barrel 6 and outer barrel 8. While not to be limited by theory, it is believed that the noise is the result of air turbulence generated as the gases move between the inner barrel 6 and outer barrel 8.

The noise generated by the device can be altered by altering the parameters of the both the inner barrel 6 and outer barrel 8. Parameters include; length, diameter, shape, cross-sectional shape, and the ratio of the length of the inner barrel 6 to the outer barrel 8. The inner barrel 6 may also extend into the combustion chamber 7 to alter the sound characteristics.

It will be appreciated that the size and shape of the combustion chamber 2 may also vary greatly, and that by altering the combustion chamber can also alter the characteristics of the noise generated and its intensity.

While the initial blast can startle birds the secondary noise generated can last for several seconds and produces a suitable reverberating noise to scare away birds for some distance.

It will be appreciated that an integrated management system, such as a computer or similar automated system, could be used to control the firing of the device. The system could control all parameters such as filling of the combustion chamber with the combustible gases, ignition, as well as rates of firing. For bird scaring the device could be set to fire at regular intervals or at random intervals.

The noise produced by the present invention can be effective over a large area. Furthermore, because the device does not fire a projectile, and is a contained blast it can be used with safety, especially where people are likely to be present, such as airports.

The present device also has the benefit that it can be pivotally mounted such that it the noise and shock wave can be directed towards a particular area. This is useful to help keep birds away from a particular area or structure. This aspect is also particularly advantageous as it means that the noise shock wave can be directed towards a particular snow slope to initiate an avalanche. This allows for controlled avalanches to be initiated in dangerous areas to prevent the build up of snow and an increased risk of larger uncontrolled avalanches occurring.

Wherein in the foregoing description, reference has been made to features having known equivalents, those equivalents are hereby incorporated as if they have been specifically set forth.

Although the invention has been described by way of example, it should be appreciated that variations and modifications may be made without departing from the scope of the invention.

1. A noise generating device comprising:
an enclosed combustion chamber having a single exit opening;
a means for introducing a combustible material;
an ignition means;
an inner barrel extending away from the combustion chamber exit opening; and
an outer barrel extending away from the combustion chamber exit opening and surrounding said inner barrel; wherein said outer barrel extends beyond said inner barrel.

2. A device according to claim 1, wherein the outer barrel extends from the end of the inner barrel.

3. A device according to claim 1, when said outer barrel extends outwards from a centre line at an angle of between 0 and 45° C. forming an inverted cone.

4. A device according to claim 1, wherein the combustion chamber comprises one or more one-way valves that allow gases to enter said chamber.

5. A device according to claim 4, wherein the one or more valves may comprise an opening in the combustion chamber that has a sealing flap that opens into the combustion chamber.

6. A device according to claim 4, wherein the flat of the inlet valve may be biased in an open position.

7. A device according to claim 1, wherein the combustion chamber is tapered to the exit opening.

8. A device according to claim 7, wherein the tapering of the combustion chamber is between 0 and 90° C.

9. A device according to claim 1 further comprising an integrated management system capable of controlling the filling of the combustion chamber with a combustible material and firing of the device.

10. A device according to claim 1 further comprising a pivotable and rotatable mounting system.

11. A device according to claim 1 for use as a bird scarer.

12. A device according to claim 1 for use as an avalanche-inducing device.

13. A method for generating a noise using a device according to claim 1 comprising the steps of:
introducing a combustible material into the combustion chamber; and
igniting said combustible material;
wherein the exiting of the expanding combustible gases through the inner and outer barrel produces an audible sound.

14. A method according to claim 13, wherein the combustible material is a gas.

15. A method according to claim 13, wherein the gas is acetylene.

16. A method according to claim 13, wherein oxygen is also introduced into the combustion chamber prior to ignition.

17. A method according to claim 13, wherein the steps are controlled by an integrated management system.

18. A method according to claim 13, wherein the method is performed to scare birds.

19. A method according to claim 13, wherein the method is performed to induce an avalanche.
